(19) United States
(12) Patent Application Publication
(10) Pub. No.: US 2021/0065719 A1
(43) Pub. Date: Mar. 4, 2021

(54) METHODS AND SYSTEMS FOR INTELLIGENT CONTENT CONTROLS

(71) Applicant: COMCAST CABLE COMMUNICATIONS, LLC, Philadelphia, PA (US)

(72) Inventors: HONGCHENG WANG, Arlington, VA (US); Rui MIN, Vienna, VA (US); Tianwen CHEN, Mclean, VA (US)

(21) Appl. No.: 16/555,756

(22) Filed: Aug. 29, 2019

(51) Int. Cl. G10L 17/00; G10L 17/06; G10L 17/02

(52) U.S. Cl. CPC G10L 17/005; G10L 17/02; G10L 17/06

(57) ABSTRACT

Provided are methods and systems for intelligent content controls. A command may be received during presentation of content. The command may be time-driven, context-driven, or a combination of both. An end boundary may be determined based on a duration of time and/or one or more words of the command. Presentation of the content may be terminated at a nearest content transition with respect to the end boundary.

### BACKGROUND

Conventional content controls, such as parental controls and user device timers, merely disable access to content after a time has elapsed. Such content controls lack the capability to be context-driven. This can lead to a poor user experience when viewing content, since conventional content controls may cause presentation of content to be terminated at inopportune moments, such as near an ending of a current scene boundary or directly after a beginning of a next scene. Further, conventional content controls are not able to cause presentation of content to be terminated based on context-driven commands. These and other shortcomings are addressed by the approaches set forth herein.

### SUMMARY

It is to be understood that both the following general description and the following detailed description are exemplary and explanatory only and are not restrictive. Methods and systems for providing intelligent content controls and enforcing the same during presentation of content are described herein. Content, such as a movie, television program, and the like, may be presented on a display device (e.g., a television, a mobile device, etc.). Prior to, or during, presentation of the content, a user may exercise control over the presentation of the content (e.g., terminate the presentation at a future time). For example, a parent may exercise control over a child's viewing of the presentation of the content (e.g., to limit “screen time,” to prepare for bedtime, etc.). The parent may send a voice command to a voice-enabled device during, or prior to, presentation of the content. The command may contain one or more search terms and/or phrases that the voice-enabled device may use to determine an end boundary (e.g., an occurrence and/or timestamp in the content at which presentation is to be terminated). The command may be time-driven, context-driven, or a combination of both. For example, the command may indicate presentation of the content is to end a certain time; after a specified event occurs within the content; or at a certain time and/or at a specified event (e.g., whichever occurs first).

Content metadata may be searched to identify a position in the content using timestamps. A timestamp can be determined that corresponds to the one or more search terms and/or phrases, such as a timestamp corresponding to an amount of time indicated by the command (e.g., “Turn the television off in 20 minutes”) or a timestamp contextually related to one or more words in the command (e.g., “Turn the television off after the princess has been saved.”). Upon identifying the timestamp of the content that corresponds to the one or more search terms and/or phrases, an end boundary may be determined. The end boundary may correspond to a content transition nearest the identified timestamp (e.g., a shot change, a scene change, etc.). Presentation of the content may be terminated at the end boundary (e.g., at the nearest content transition) rather than abruptly at the identified timestamp. Additional advantages will be set forth in part in the description which follows or may be learned by practice. The advantages will be realized and attained by means of the elements and combinations particularly pointed out in the appended claims.

### BRIEF DESCRIPTION OF THE DRAWINGS

The accompanying drawings, which are incorporated in and constitute a part of this specification, show examples and together with the description, serve to explain the principles of the methods and systems:

FIG. 1 shows a diagram of an example content delivery network;

FIG. 2 shows a diagram of an example operating environment;

FIG. 3 shows an example search and video analysis environment;

FIG. 4 shows an example video analysis environment;

FIG. 5 shows a diagram of example components of the search component;

FIG. 6 shows an example user profile interface;

FIG. 7 shows an example operation of a machine learning component;

FIG. 8 shows a flowchart of an example method;

FIG. 9 shows a flowchart of an example method;

FIG. 10 shows a flowchart of an example method; and

FIG. 11 shows a diagram of an example computing device.

### DETAILED DESCRIPTION

Before the present methods and systems are disclosed and described, it is to be understood that the methods and systems are not limited to specific methods, specific components, or to particular implementations. It is also to be understood that the terminology used herein is for the purpose of describing particular embodiments only and is not intended to be limiting.

As used in the specification and the appended claims, the singular forms “a,” “an,” and “the” include plural referents unless the context clearly dictates otherwise. Ranges may be expressed herein as from “about” one particular value, and/or to “about” another particular value. When such a range is expressed, another embodiment includes from the one particular value and/or to the other particular value. Similarly, when values are expressed as approximations, by use of the antecedent “about,” it will be understood that the particular value forms another embodiment. It will be further understood that the endpoints of each of the ranges are significant both in relation to the other endpoint, and independently of the other endpoint. “Optional” or “optionally” means that the subsequently described event or circumstance may or may not occur, and that the description includes instances where said event or circumstance occurs and instances where it does not.

Throughout the description and claims of this specification, the word “comprise” and variations of the word, such as “comprising” and “comprises,” means “including but not limited to,” and is not intended to exclude, for example, other components, integers or steps. “Exemplary” means “an example of” and is not intended to convey an indication of a preferred or ideal embodiment. “Such as” is not used in a restrictive sense, but for explanatory purposes.

Described herein are components that may be used to perform the described methods and systems. These and other components are described herein, and it is understood that when combinations, subsets, interactions, groups, etc. of these components are described that while specific reference of each various individual and collective combinations and permutation of these may not be explicitly disclosed, each is specifically contemplated and described herein, for all methods and systems. This applies to all examples of this application including, but not limited to, steps in the described methods. Thus, if there are a variety of additional steps that may be performed it is understood that each of these additional steps may be performed with any specific embodiment or combination of embodiments of the described methods.

The present methods and systems may be understood more readily by reference to the following detailed description of preferred embodiments and the examples included therein and to the Figures and their previous and following description. As will be appreciated by one skilled in the art, the methods and systems may take the form of an entirely hardware embodiment, an entirely software embodiment, or an embodiment combining software and hardware examples. Furthermore, the methods and systems may take the form of a computer program product on a computer-readable storage medium having computer-readable program instructions (e.g., computer software) embodied in the storage medium. More particularly, the present methods and systems may take the form of web-implemented computer software. Any suitable computer-readable storage medium may be utilized including hard disks, CD-ROMs, optical storage devices, or magnetic storage devices.

Embodiments of the methods and systems are described below with reference to block diagrams and flowcharts methods, systems, apparatuses and computer program products. It will be understood that each block of the block diagrams and flowcharts, and combinations of blocks in the block diagrams and flowcharts, respectively, may be implemented by computer program instructions. These computer program instructions may be loaded onto a general purpose computer, special purpose computer, or other programmable data processing apparatus to produce a machine, such that the instructions which execute on the computer or other programmable data processing apparatus create a means for implementing the functions specified in the flowchart block or blocks.

These computer program instructions may also be stored in a computer-readable memory that may direct a computer or other programmable data processing apparatus to function in a particular manner, such that the instructions stored in the computer-readable memory produce an article of manufacture including computer-readable instructions for implementing the function specified in the flowchart block or blocks. The computer program instructions may also be loaded onto a computer or other programmable data processing apparatus to cause a series of operational steps to be performed on the computer or other programmable apparatus to produce a computer-implemented process such that the instructions that execute on the computer or other programmable apparatus provide steps for implementing the functions specified in the flowchart block or blocks.

Accordingly, blocks of the block diagrams and flowcharts support combinations of means for performing the specified functions, combinations of steps for performing the specified functions and program instruction means for performing the specified functions. It will also be understood that each block of the block diagrams and flowcharts, and combinations of blocks in the block diagrams and flowcharts, may be implemented by special purpose hardware-based computer systems that perform the specified functions or steps, or combinations of special purpose hardware and computer instructions.

In various examples, this detailed description may refer to video clips or content items (which may also be referred to as “content,” “content data,” “content information,” “content asset,” “multimedia asset data file,” or simply “data” or “information”). In some examples, video clips or content items may be any information or data that may be licensed to one or more individuals (or other entities, such as business or group). In various examples, video clips or content may include electronic representations of video, audio, text and/or graphics, which may include but is not limited to electronic representations of videos, movies, or other multimedia, which may include but is not limited to data files adhering to MPEG2, MPEG, MPEG4 UHD, HDR, 4K, Adobe® Flash® Video (.FLV) format or some other video file format whether such format is presently known or developed in the future. In various examples, the content items described herein may include electronic representations of music, spoken words, or other audio, which may include but is not limited to data files adhering to the MPEG-1 Audio Layer 3 (.MP3) format, Adobe®, CableLabs 1.0, 1.1, 3.0, AVC, HEVC, H.264, Nielsen watermarks, V-chip data and Secondary Audio Programs (SAP). Sound Document (.ASND) format or some other format configured to store electronic audio whether such format is presently known or developed in the future.

In some cases, video clips or content may include data files adhering to the following formats: Portable Document Format (.PDF), Electronic Publication (.EPUB) format created by the International Digital Publishing Forum (IDPF), JPEG (.JPG) format, Portable Network Graphics (.PNG) format, dynamic ad insertion data (.csv), Adobe® Photoshop® (.PSD) format or some other format for electronically storing text, graphics and/or other information whether such format is presently known or developed in the future. In some examples, content items may include any combination of the above-described examples. Described herein are various examples that may refer to consuming content or to the consumption of content, which may also be referred to as “accessing” content, “providing” content, “viewing” content, “listening” to content, “rendering” content, or “playing” content, among other things. In some cases, the particular term utilized may be dependent on the context in which it is used. For example, consuming video may also be referred to as viewing or playing the video. In another example, consuming audio may also be referred to as listening to or playing the audio.

Described herein are systems and methods for providing intelligent content controls and enforcing the same during presentation of content. A command may be received via a voice-enabled device during, or prior to, presentation of content at a user device, such as a television, set-top box, mobile device, computing device, a combination thereof, and/or the like. The command may be time-driven, context-driven, or both. As an example, the command may be received by a voice-enabled device, such as a remote control for a television, a set-top box, a smart speaker and the like.

The command may be time-driven. A portion of the command (e.g., one or more of the search terms and/or phrases) may be indicative of a duration of time. The command may be received at a first timestamp of the content. A time-driven command may include a phrase, such as “Turn the television off in 20 minutes,” in which case the duration of time would be 20 minutes and the first timestamp would be a timestamp of content that corresponds to the time at which the time-driven command was received. A second timestamp may be determined using the duration of time and the first timestamp. In the preceding example, the second timestamp may be a timestamp of content that corresponds to 20 minutes after the first timestamp. An end boundary may be determined based on the second timestamp and a nearest content transition (e.g., a shot change, a scene change, etc.) with respect to the second timestamp. The user device may terminate presentation of content at the end boundary, which may be a next scene, a next shot, a next commercial break, and/or the like.

The command may be context-driven. A context-driven command may include a phrase, such as “Turn the television off once the princess has been saved.” Content metadata may be searched to identify an occurrence of the one or more search terms and/or phrases. In the preceding example, the one or more search terms and/or phrases that may be relevant to the context-driven command may be “saved” and “princess.” Upon identifying an occurrence of the one or more search terms and/or phrases, an end boundary may be determined. The end boundary may be a content transition nearest the occurrence of the one or more search terms and/or phrases (e.g., a shot change, a scene change, etc.). Presentation of the content may be terminated at a timestamp associated with the end boundary (e.g., at the nearest content transition). In the preceding example, the timestamp associated with the end boundary may be a content transition that occurs directly after the princess being saved.

The command may be a combination of being time-driven and context-driven (“combination command”). A combination command may include a phrase, such as “Turn the television off once the princess has been saved or after 20 minutes.” A portion of the combination command (e.g., one or more of the search terms and/or phrases) may be indicative of a duration of time. The combination command may be received at a first timestamp of the content. In the preceding example, the duration of time would be 20 minutes and the first timestamp would be a timestamp of content that corresponds to the time at which the combination command was received. A second timestamp may be determined using the duration of time and the first timestamp. In the preceding example, the second timestamp may be a timestamp of content that corresponds to 20 minutes after the first timestamp.

Content metadata may be searched to identify an occurrence of the one or more search terms and/or phrases in the combination command. In the preceding example, the one or more search terms and/or phrases that may be relevant to the combination command may be “saved” and “princess.” Upon identifying an occurrence of the one or more search terms and/or phrases, an end boundary may be determined. The end boundary may be a content transition nearest the occurrence of the one or more search terms and/or phrases (e.g., a shot change, a scene change, etc.). The end boundary may correspond to a timestamp that is after the second timestamp (e.g., greater than 20 minutes after the combination command having been received). A user profile may dictate how the combination command is to be processed in such a scenario. After presentation of content is terminated, the user device that was presenting the content may be caused to be unresponsive to further commands received for a given amount of time.

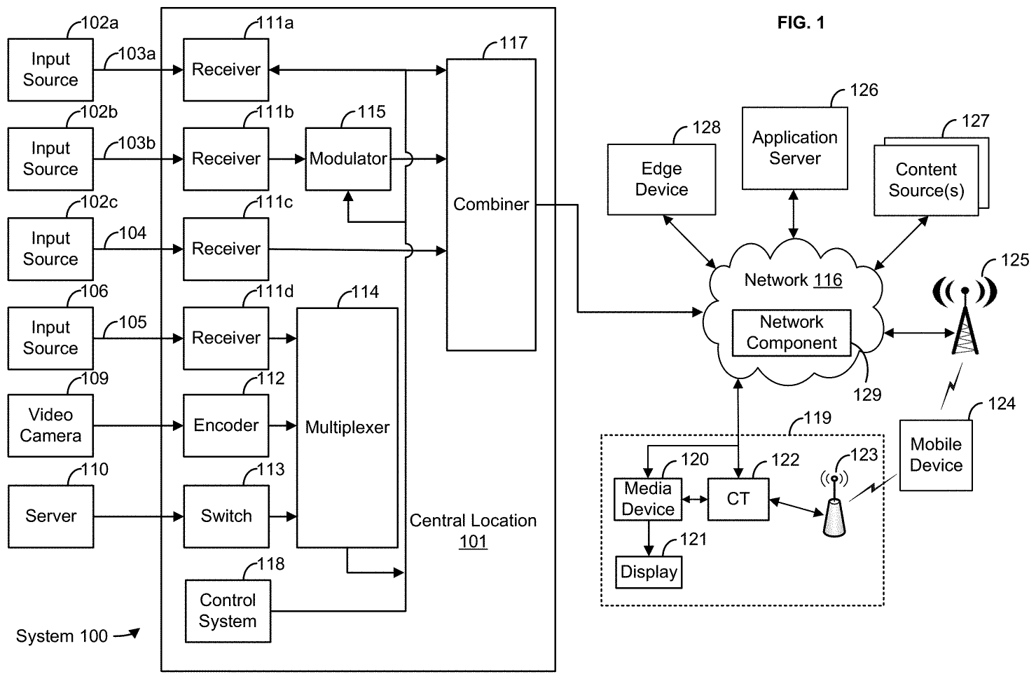

FIG. 1 shows an example system in which the present methods and systems may operate. Those skilled in the art will appreciate that the present methods may be used in systems that employ both digital and analog equipment. One skilled in the art will appreciate that provided herein is a functional description and that the respective functions may be performed by software, hardware, or a combination of software and hardware. A system 100 may include a central location 101 (e.g., a headend), which may receive content (e.g., data, input programming, and the like) from multiple sources. The central location 101 may combine the content from the various sources and may distribute the content to user (e.g., subscriber) locations (e.g., location 119) via a network 116.

In an example, the central location 101 may receive content from a variety of sources 102a, 102b, 102c. The content may be transmitted from the source to the central location 101 via a variety of transmission paths, including wireless (e.g. satellite paths 103a, 103b) and a terrestrial path 104. The central location 101 may also receive content from an input source 106 via a direct line 105. Other input sources may include capture devices such as a video camera 109 or a server 110. The signals provided by the content sources may include a single content item or a multiplex that includes several content items.

The central location 101 may have one or a plurality of receivers 111a, 111b, 111c, 111d that are each associated with an input source. For example, MPEG encoders such as an encoder 112, are included for encoding local content or a video camera 109 feed. A switch 113 may provide access to the server 110, which may be a Pay-Per-View server, a data server, an internet router, a network system, a phone system, and the like. Some signals may require additional processing, such as signal multiplexing, prior to being modulated. Such multiplexing may be performed by a multiplexer (mux) 114.

The central location 101 may have one or a plurality of modulators 115 for interfacing to the network 116. The modulators 115 may convert the received content into a modulated output signal suitable for transmission over a network 116. The output signals from the modulators 115 may be combined, using equipment such as a combiner 117, for input into the network 116. In an example, the network 116 may be a content delivery network, a content access network, and/or the like. For example, the network 116 may be configured to provide content from a variety of sources using a variety of network paths, protocols, devices, and/or the like. The content delivery network and/or content access network may be managed (e.g., deployed, serviced) by a content provider, a service provider, and/or the like.

A control system 118 may permit a system operator to control and monitor the functions and performance of the system 100. The control system 118 may interface, monitor, and/or control a variety of functions, including, but not limited to, the channel lineup for the television system, billing for each user, conditional access for content distributed to users, and the like. The control system 118 may provide input to the modulators for setting operating parameters, such as system specific MPEG table packet organization or conditional access information. The control system 118 may be located at the central location 101 or at a remote location.

The network 116 may distribute signals from the central location 101 to user locations, such as a user location 119. The network 116 may be an optical fiber network, a coaxial cable network, a hybrid fiber-coaxial network, a wireless network, a satellite system, a direct broadcast system, an Ethernet network, a high-definition multimedia interface network, universal serial bus network, or any combination thereof. In an example, a multitude of users may be connected to the network 116 at one or more of the user locations. At the user location 119, a media device 120 may demodulate and/or decode, if needed, the signals for display on a display device 121, such as on a television set (TV) or a computer monitor. For example, the media device 120 may have a demodulator, decoder, frequency tuner, and/or the like. The media device 120 may be directly connected to the network (e.g., for communications via in-band and/or out-of-band signals of a content delivery network) and/or connected to the network 116 via a communication terminal 122 (e.g., for communications via a packet switched network). The media device 120 may be a set-top box, a digital streaming device, a gaming device, a media storage device, a digital recording device, a combination thereof, and/or the like. The media device 120 may have one or more applications, such as content viewers, social media applications, news applications, gaming applications, content stores, electronic program guides, and/or the like. Those skilled in the art will appreciate that the signal may be demodulated and/or decoded in a variety of equipment, including the communication terminal 122, a computer, a TV, a monitor, or satellite dish.

In an example, the communication terminal 122 may be located at the user location 119. The communication terminal 122 may be configured to communicate with the network 116. The communications terminal 122 may include a modem (e.g., cable modem), a router, a gateway, a switch, a network terminal (e.g., optical network unit), and/or the like. The communications terminal 122 may be configured for communication with the network 116 via a variety of protocols, such as internet protocol, transmission control protocol, file transfer protocol, session initiation protocol, voice over internet protocol, and/or the like. For example, for a cable network, the communication terminal 122 may be configured to provide network access via a variety of communication protocols and standards, such as Data Over Cable Service Interface Specification.

In an example, the user location 119 may include a first access point 123, such as a wireless access point. The first access point 123 may be configured to provide one or more wireless networks in at least a portion of the user location 119. The first access point 123 may be configured to provide access to the network 116 to devices configured with a compatible wireless radio, such as a mobile device 124, the media device 120, the display device 121, or other computing devices (e.g., laptops, sensor devices, security devices). For example, the first access point 123 may provide a user managed network (e.g., local area network), a service provider managed network (e.g., public network for users of the service provider), and/or the like. It should be noted that in some configurations, some or all of the first access point 123, the communication terminal 122, the media device 120, and the display device 121 may be implemented as a single device.

In an example, the user location 119 may not be fixed. By way of example, a user may receive content from the network 116 on the mobile device 124. The mobile device 124 may be a laptop computer, a tablet device, a computer station, a personal data assistant (PDA), a smart device (e.g., smart phone, smart apparel, smart watch, smart glasses), GPS, a vehicle entertainment system, a portable media player, a combination thereof, and/or the like. The mobile device 124 may communicate with a variety of access points (e.g., at different times and locations or simultaneously if within range of multiple access points). For example, the mobile device 124 may communicate with a second access point 125. The second access point 125 may be a cell tower, a wireless hotspot, another mobile device, and/or other remote access point. The second access point 125 may be within range of the user location 119 or remote from the user location 119. For example, the second access point 125 may be located along a travel route, within a business or residence, or other useful locations (e.g., travel stop, city center, park).

In an example, the system 100 may include an application server 126. The application server 126 may be a computing device, such as a server. The application server 126 may provide services related to applications. For example, the application server 126 may include an application store. The application store may be configured to allow users to purchase, download, install, upgrade, and/or otherwise manage applications. For example, the application server 126 may be configured to allow users to download applications to a device, such as the mobile device 124, communications terminal 122, the media device 120, the display device 121, and/or the like. The application device 126 may run one or more application services to provide data, handle requests, and/or otherwise facilitate operation of applications for the user.

In an example, the system 100 may have one or more content source(s) 127. The content source(s) 127 may be configured to provide content (e.g., video, audio, games, applications, data) to the user. The content source(s) 127 may be configured to provide streaming media, such as on-demand content (e.g., video on-demand), content recordings, and/or the like. For example, the content source(s) 127 may be managed by third party content providers, service providers, online content providers, over-the-top content providers, and/or the like. The content may be provided via a subscription, by individual item purchase or rental, and/or the like. The content source(s) 127 may be configured to provide the content via a packet switched network path, such as via an internet protocol (IP) based connection. In an example, the content may be accessed by users via applications, such as mobile applications, television applications, set-top box applications, gaming device applications, and/or the like. An example application may be a custom application (e.g., by content provider, for a specific device), a general content browser (e.g., web browser), an electronic program guide, and/or the like.

In an example, the system 100 may include an edge device 128. The edge device 128 may be configured to provide content, services, and/or the like to the user location 119. For example, the edge device 128 may be one of a plurality of edge devices distributed across the network 116. The edge device 128 may be located in a region proximate to the user location 119. A request for content from the user may be directed to the edge device 128 (e.g., due to the location of the edge device and/or network conditions). The edge device 128 may be configured to package content for delivery to the user (e.g., in a specific format requested by a user device such as the media device 120 or other user device), provide the user a manifest file (e.g., or other index file describing segments of the content), provide streaming content (e.g., unicast, multicast), provide a file transfer, and/or the like. The edge device 128 may cache or otherwise store content (e.g., frequently requested content) to enable faster delivery of content to users.

The network 116 may include a network component 129. The network component 129 may be any device, module, and/or the like communicatively coupled to the network 116. The network component 129 may include a router, a switch, a splitter, a packager, a gateway, an encoder, a storage device, a multiplexer, a network access location (e.g., tap), physical link, and/or the like. Some or all examples of the methods described herein may be performed via the network component 129.

A component of the system may receive and process queries (e.g., received from a user). While the following example describes the receipt and processing of a query as being performed by the media device 120, it is to be understood that other devices shown in FIG. 1 may perform some or all of these actions. For example, these actions may be performed by the edge device 128, the application server 126, the network component 129, or the mobile device 124. The query may correspond to a command received, such as a time-based command, a context-based command, or a combination command as discussed herein. For example, the query may be a voice query provided to the media device 120 (e.g., a set-top box or other user device to which content is being transmitted). As another example, the query may be a voice query provided to a control device, such as a remote control, of the media device 120. As a further example, the query may be a voice query provided to a computing device configured to listen for ambient trigger keywords in order to initiate reception of the voice query, such as a smart speaker (e.g., AMAZON ALEXA; AMAZON ECHO; GOOGLE HOME; APPLE HOMEPOD; etc.). In yet another example, the query may be a text query transmitted by a user device, e.g., a mobile device, remote control, keypad, etc. The query may include one or more keywords and/or phrases. The query may include a plurality of keywords and/or phrases. For example, a query of “Turn the TV off after the princess is saved from the battle,” may include the keywords and/or phrases “princess” and “battle.”

In response to receiving the query, the media device 120 may determine what content item is presently being transmitted to, or otherwise consumed by, the media device 120. The content item may be a pre-recorded content item, a linear content item, a non-linear content item, and the like. For example, the content item may be a linear content item that is being recorded and/or stored as it is consumed. Determining what content item is being transmitted to, or otherwise consumed by, the media device 120 may include accessing request logs, transmissions, or other data associated with the media device 120 that may identify the content. Determining what content item is being transmitted to the media device 120 may also include transmitting a request to the user device to identify the content.

The media device 120 may determine if the one or more matching keywords and/or phrases exists in metadata associated with the determined content item. The metadata may be associated with a linear content item or a non-linear content item. Metadata associated with a linear content item (e.g., linear content metadata) may be metadata generated/received as linear content is streamed/received. In an example, in response to receiving the query, the media device 120 may determine if the one or more matching keywords and/or phrases exists in metadata associated with any number of linear content streams. Metadata associated with a non-linear content item (e.g., non-linear content metadata) may be metadata that is received as non-linear content is requested (e.g., from an on-demand service).

The media device 120 may determine if the one or more matching keywords and/or phrases exists in metadata associated with the content item and/or any available content stream. In an example, in response to receiving the query, the media device 120 may determine if the one or more matching keywords and/or phrases exists in metadata associated with the content item and/or any available content stream. The media device 120 may use an identifier of the content item and/or any available content stream to access the metadata associated with the content item and/or any available content stream. The media device 120 may treat the query as a traditional search statement wherein the entirety of the statement must be present in the metadata to initiate a process of identifying boundaries for a content segment, such as a video clip. The media device 120 may tokenize the query and separate the query out into portions and once at least one of the portions of the query is present in the metadata a process of identifying boundaries for a content segment may be initiated. The media device 120 may treat the query as both a traditional search statement and a tokenized query. For example, the media device 120 may treat the query as a traditional search statement to initially identify a content item for further search via tokenized query.

The media device 120 may include Natural Language Processing (NLP) in order to process the query. For example, the media device 120 may use the NLP to determine terms that are logically associated with the query to broaden the search. As an example, a search for “battle” may include other terms such as “fight,” “war,” “contest”, and so forth such that the media device 120 can search for terms that are logically associated with the term “battle.” As another example, the media device 120 may include Query Expansion (QE). In an example, QE evaluates a search term and expands the search query. For example, QE may determine synonyms of words in the search and then search for the synonyms, fix spelling errors, determine any other spellings of the words in the search, and so forth to expand the query beyond the literal search terms.

By way of example, the metadata may include one or more of, dialogue data, shot change data, scene change data, advertisement break data, social metadata, combinations thereof, and the like. Dialogue data may be, for example, closed captioning data and/or speech-to-text data). Shot change data may represent shot boundaries within the content item. Shot boundaries are points of non-continuity in the video (e.g., associated with a change in a camera angle or a scene). Shot change data may be detected by video analysis. A shot change may also represent a start or end of a commercial/advertisement. Scene change data may represent a start or end of a scene. Scene change data may be detected by video analysis. A scene change may also represent a start or end of commercial/advertisement. Advertisement break data may represent a start or end of a commercial/advertisement and/or group of commercials/advertisements. Advertisement break data may be detected by video analysis or may be signaled within closed captioning data and/or a manifest). Social metadata may include communications from users of a social platform such as Tweets, posts, comments, etc.

The media device 120 may generate/receive the metadata from one or more content streams as the one or more content streams are received/requested. The media device 120 may be configured to extract closed caption data from the one or more content streams along with associated timestamps. The media device 120 may be configured to determine one or more content transitions, by, for example, accessing one or more manifest files and determining advertisement break data. A content transition may be, for example, a shot change (also referred to as a shot boundary), a scene change (also referred to as a scene boundary), a combination thereof, and the like. The media device 120 may further determine content transitions through video analysis as described herein. The media device 120 may further generate a program transcript document by extracting dialogue data, timestamps, and content transition data from the metadata and appending the dialogue data, the timestamps, and the content transition data to a program transcript document. The program transcript document may be maintained for any length of time.

The media device 120 may determine an end boundary of the content associated with one or more matches found in the metadata. The media device 120 may determine one or more content transitions before and/or after a time of a query match. For example, previous transitions may be stored in a memory associated with the media device 120, and new content transitions may be determined while the media device 120 receives the content streams. For example, the media device 120 may store the content transitions in a content transition timeline. The content transition timeline may include any suitable data structure. In an example, the media device 120 may set a first occurring scene boundary as an initial temporary boundary. The media device 120 may then determine whether the initial temporary boundary is a true boundary. For example, in the event that both keywords and/or phrases occur before the next scene boundary, the initial temporary boundary may be confirmed as a true boundary. If only one of the keywords and/or phrases occur before the next scene boundary, the next scene boundary may be set as the initial temporary boundary. In an example, the initial boundary is not a temporary boundary. Rather, the initial boundary is immediately treated like the true boundary without the need for confirmation.

In another example, an end boundary may be set by adding a predetermined duration (e.g., as provided with the command received) to the timestamp associated with the match and determining a shot change or a scene change closest in time to that resulting time point. In one example, once the determined duration has passed, the next shot change or scene change may then be set as the end boundary. If the end time of the content item is between the timestamp and the predetermined second duration, then the end time of the content item may be set as the end boundary.

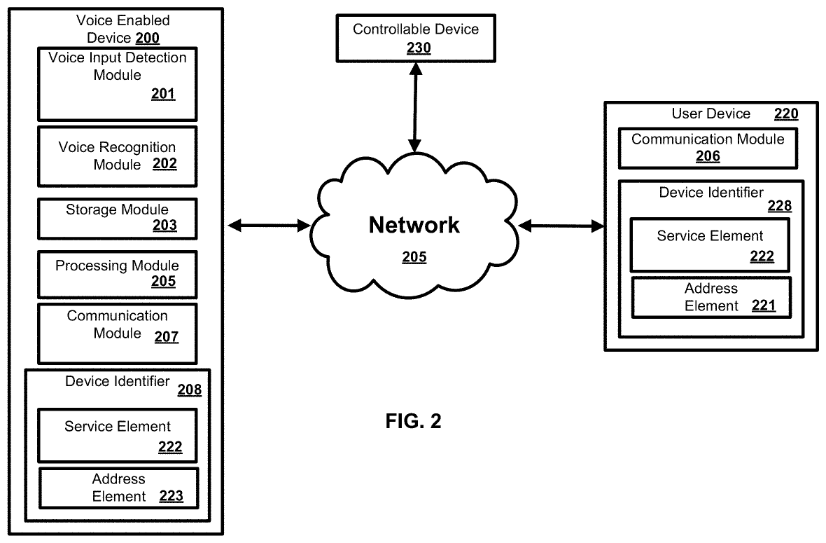

FIG. 2 illustrates various aspects of an example operating environment in which the present methods and systems for providing intelligent content controls and enforcing the same during presentation of content can operate. One or more computing devices may be configured to provide various services such as user identity verification and authentication services to one or more devices, such as voice-enabled devices and/or devices controlled by voice-enabled devices. Those skilled in the art will appreciate that the present methods may be used in various types of networks and systems that employ both digital and analog equipment. One skilled in the art will appreciate that provided herein is a functional description and that the respective functions may be performed by software, hardware, or a combination of software and hardware.

An example environment can include a voice-enabled device 200 (e.g., a smart speaker, a system control device, a user device, a communications terminal, a wireless device, a media device, etc.). The voice-enabled device 200 may be in communication with a network such as a network 205. The network 205 may be a network such as the Internet, a wide area network, a local area network, a cellular network, a satellite network, and the like. Various forms of communications can occur via the network 205. The network 205 can include wired and wireless communications and communication techniques.

The voice-enabled device 200 may be associated with a device identifier 208. As an example, the device identifier 208 may be any identifier, token, character, string, or the like, for differentiating one voice-enabled device from another voice-enabled device. The device identifier 208 can identify voice-enabled device 200 as belonging to a particular class of voice-enabled devices. As a further example, the device identifier 208 can include information relating to the voice-enabled device 200 such as a manufacturer, a model or type of device, a service provider associated with the voice-enabled device 200, a state of the voice-enabled device 200, a locator, and/or a label or classifier. Other information may be represented by the device identifier 208.

The device identifier 208 may include an address element 223 and a service element 222. The address element 223 may indicate or provide an internet protocol address, a network address, a media access control (MAC) address, an Internet address, or the like. For example, the address element 223 may be relied upon to establish a communication session between the voice-enabled device 200 and a user device 220, a computing device, or other devices and/or networks. The address element 223 may be used as an identifier or locator of the voice-enabled device 200. The address element 223 may be persistent for a particular network.

The service element 222 may indicate an identification of a service provider associated with the voice-enabled device 200 and/or with the class of voice-enabled device 200. The class of the voice-enabled device 200 may be related to a type of device, capability of device, type of service being provided, and/or a level of service (e.g., business class, service tier, service package, etc.). For example, the service element 222 may include information relating to or provided by a communication service provider (e.g., Internet service provider) that is providing or enabling data flow such as communication services to the voice-enabled device 200. The service element 222 may include information relating to a preferred service provider for one or more particular services relating to the voice-enabled device 200. In an aspect, the address element 223 may be used to identify or retrieve data from the service element 222, or vice versa. One or more of the address element 223 and the service element 222 may be stored remotely from the voice-enabled device 200 and retrieved by one or more devices such as the voice-enabled device 200, the user device 220, and/or and a computing device, for example. Other information may be represented by the service element 222.

The voice-enabled device 200 may include a voice input detection module 201 for detecting an audible input, such as a voice input. For example, the voice input detection module 201 may detect a user speaking near the voice-enabled device 200 and the like. The voice input detection module 201 may include one or more microphones, speakers, combinations thereof, and the like. The one or more a microphones, speakers, combinations thereof, and the like may receive the voice input from the user, and provide the voice input to a voice recognition module 202.

To control the one or more functions/services associated with the voice-enabled device 200, the voice recognition module 202 may process the voice input. The voice recognition module 202 may perform speech-to-text operations that translate spoken words (e.g., voice input) into text, other characters, or commands. The voice recognition module 202 may apply one or more voice recognition algorithms to the voice input to extract a word or words (e.g., phrase). The voice recognition module 202 may be configured to convert the word or words to text and compare the text to a list of words stored in storage module 203. The voice-enabled device 200 may associate/map the text to one or more operational commands stored in the storage module 203. As such, the voice-enabled device 200 may determine operational commands from the voice input. The operational commands may be used to control one or more functions/services associated with the voice-enabled device 200. The operational commands may be used to control a controllable device 230 in communication with the voice-enabled device 200. The controllable device 230 may be a set-top box, a media player, a device configured to present content, and/or a device configured to control a content presentation device in communication therewith. The voice-enabled device 200 may transmit one or more operational commands to the controllable device 230 after the voice input in verified and/or authenticated as being associated with a particular individual. For example, the voice-enabled device 200 may transmit one or more operational commands to the controllable device 230 after the voice input in verified and/or authenticated as being associated with the individual suspected to be providing the voice input.

To verify and/or authenticate the voice input as being associated with the individual suspected to be providing the voice input (e.g., a parent/authorized user versus a child or other non-authorized user), the voice recognition module 202 may process the voice input. The voice recognition module 202 may process the voice input by analyzing one or more voice characteristics associated with the voice input. Voice characteristics may include frequency, duration, decibel level, amplitude, tone, inflection, rate of speech, volume of speech, specific phrases and/or any or such characteristic associated with a voice input. The voice recognition module 202 may identify and store (e.g., via storage module 203) voice characteristics. Voice characteristics may be combined and together can represent a voice print (e.g., a voice signature). A voice print may be associated with a particular user and stored as a profile (e.g., user profile). Therefore, to verify and/or authenticate the voice input as being associated with the individual suspected to be providing the voice input, the voice-enabled device 200 may determine, based on one or more voice characteristics, a voice print. The voice-enabled device 200 may compare the voice print to one or more stored voice prints (e.g., voice prints stored as profiles). The voice-enabled device 200 can determine that the voice print matches a stored voice print and is thus associated with a profile. The profile may be associated with one or more user devices, such as the user device 220.

The user device 220 may be an electronic device such as a television, a computer, a smartphone, a mobile device, a laptop, a tablet, or any other device capable of communicating with the voice-enabled device 200 or any other device in communication with the network 205. The user device 202 may include a communication module 206 for providing an interface to a user to interact with other devices, such as the voice-enabled device 200 and/or a computing device. The communication module 206 may be any interface for presenting and/or receiving information to/from the user, such as an input (e.g., biometric input, passcode, authenticated message, combinations thereof, and the like). An example interface may be a fingerprint scanner, iris scanner, camera configured for facial recognition, keyboard, and/or a communication interface such as a web browser (e.g., Internet Explorer, Mozilla Firefox, Google Chrome, Safari, or the like). Other software, hardware, and/or interfaces may be used to provide communication between the user and one or more of the user device 220, the voice-enabled device 200, a computing device, or any other device. As an example, the communication module 206 can request or query various files from a local source and/or a remote source. As a further example, the communication element 206 can transmit data to a local or remote device such as a computing device.

The user device 220 may be associated with a device identifier 228. As an example, the device identifier 228 may be any identifier, token, character, string, or the like, for differentiating one user or user device (e.g., user device 220) from another user or user device. The device identifier 228 may identify a user or user device as belonging to a particular class of users or user devices. As a further example, the device identifier 228 may include information relating to the user device such as a manufacturer, a model or type of device, a service provider associated with the user device 220, a state of the user device 220, a locator, and/or a label or classifier. Other information may be represented by the device identifier 228.

The device identifier 228 may include an address element 221 and a service element 222. The address element 221 may include or provide an internet protocol address, a network address, a media access control (MAC) address, an Internet address, or the like. For example, the address element 221 may be relied upon to establish a communication session between the user device 220 and the voice-enabled device 200, a computing device, or other devices and/or networks. The address element 221 may be used as an identifier or locator of the user device 220. The address element 221 may be persistent for a particular network.

The service element 222 may include an identification of a service provider associated with the user device 220 and/or with the class of user device 220. The class of the user device 220 may be related to a type of device, capability of device, type of service being provided, and/or a level of service (e.g., business class, service tier, service package, etc.). For example, the service element 222 may include information relating to or provided by a communication service provider (e.g., Internet service provider) that is providing or enabling data flow such as communication services to the user device 220. The service element 222 may include information relating to a preferred service provider for one or more particular services relating to the user device 220. In an aspect, the address element 221 may be used to identify or retrieve data from the service element 222, or vice versa. One or more of the address element 221 and the service element 222 may be stored remotely from the user device 220 and retrieved by one or more devices such as the user device 220, the voice-enabled device 200, and/or and a computing device, for example. Other information may be represented by the service element 222.

To further verify and/or authenticate the voice input as being associated with an individual suspected to be providing the voice input (e.g., a parent/authorized user versus a child or other non-authorized user), the voice-enabled device 200 may establish a communication session with the user device 220 over a network 205 via a communication module 207. The communication module 207 may include a transceiver configured for communicating information using any suitable wireless protocol, for example Wi-Fi (IEEE 802.11), BLUETOOTH®, cellular, satellite, infrared, or any other suitable wireless standard. For example, the communication module 207 can communicate with the user device 220 via a short-range communication technique (e.g., BLUETOOTH®, near-field communication, infrared, and the like). For example, the voice-enabled device 200, based on a device identifier, can transmit a short-range signal (e.g., a BLE beacon, wireless signal) that is received by the user device 220. The signal can cause the user device 220 to perform secondary (or any other subsequent) user verification and/or authentication via one or more techniques to determine that the voice input is in fact being provided by the individual suspected to be providing the voice input. For example, the user device 220 can request an input (e.g., a parental control password) from a user of the user device 220 to determine that the user is the individual suspected to be providing the voice input. The user device 220 can request a biometric input (e.g., fingerprint, iris scan, facial recognition, etc.), a passcode, an authenticated message reply, combinations thereof, and the like from the user to determine that the user is the individual suspected to be providing the voice input.

To verify and/or authenticate the voice input as being associated with the individual suspected to be providing the voice input, the voice recognition module 202 may not process the voice input. Instead, after receiving the voice input, the voice-enabled device 200 may establish a communication session with a computing device (not shown), such as a server or other network device. The voice-enabled device 200 may transmit data indicative of the voice input to the computing device via a long-range communication technique (e.g., Internet, cellular, satellite, and the like). The voice-enabled device 200 may receive an indication from the computing device that the individual providing the voice input is verified/authenticated as the individual suspected to be providing the voice input.

The voice-enabled device 200, based on the indication that the individual providing the voice input is verified/authenticated as the individual suspected to be providing the voice input, may execute a command associated with the voice input, such as a time-driven command, a context-driven command, or a combination command as discussed herein. To execute the command, the voice-enabled device 200 may use speech recognition and/or natural language processing to decipher the voice input and convert the voice input to a device executable command. Execution of the command by the voice-enabled device 200 may include the voice-enabled device 200 operating in accordance to/with the voice input. For example, execution of a voice input (e.g., voice command) “Turn off the television in 20 minutes” may cause the voice-enabled device 200 to cause the user device 220 to power off/terminate presentation of content 20 minutes after the command was received. As another example, execution of a voice input (e.g., voice command) “Turn off the television after the princess has been saved” may cause the voice-enabled device 200 to cause the user device 220 to power off/terminate presentation of content at a point in the content where it is determined (e.g., by the user device 220 or the controllable device 230 as described herein) that the princess has been saved.

The voice-enabled device 200, based on the indication that the individual providing the voice input is verified/authenticated as the individual suspected to be providing the voice input, may determine an operational command from the voice input and transmit the operational command to the controllable device 230. The controllable device 230 may execute the operational command. The voice-enabled device 200 may use speech recognition and/or natural language processing to decipher the voice input and convert the voice input to the operational command. The operational command may be a command executable by the controllable device 230. Execution of the operational command by the controllable device 230 may include the controllable device 230 operating in accordance to/with the voice input. For example, execution of an operational command derived from a voice input of “Stop playing in 20 minutes” may cause the controllable device 230, and/or any content presentation device in communication therewith, to power off/terminate presentation of content 20 minutes after the operational command was received. As another example, execution of a voice input (e.g., voice command) “Turn off the television after the princess has been saved” may cause the controllable device 230 to cause the user device 220 to power off/terminate presentation of content at a point in the content where it is determined (e.g., by the user device 220 or the controllable device 230 as described herein) that the princess has been saved.

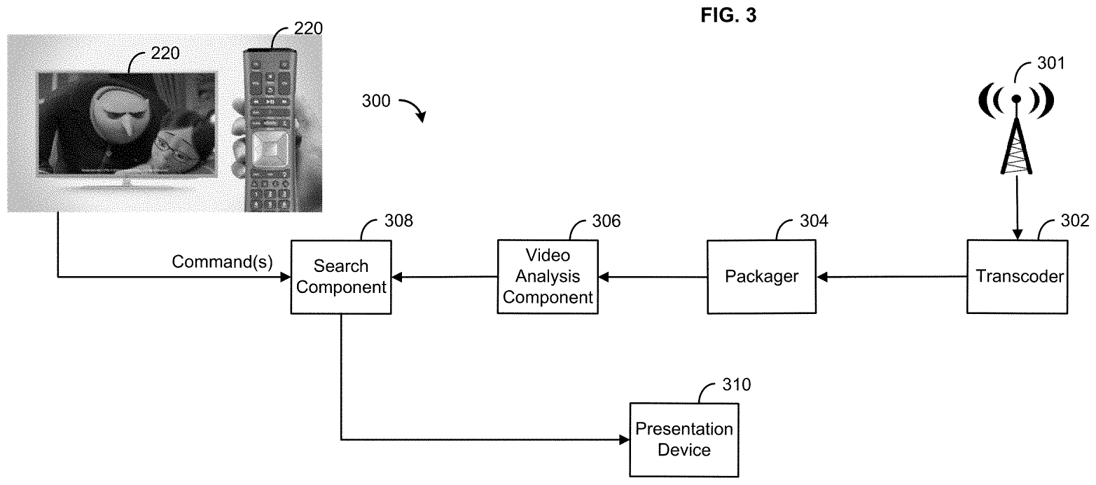

FIG. 3 shows an example search and record architecture 300. One or more of the components shown in FIG. 3 may be the media device 120 of FIG. 1, the edge device 128 of FIG. 1, the network component 129 of FIG. 1, combinations thereof, and/or the like. A transcoder 302 may receive content from a content source 301 and transcode the received content from one format to another format. The transcoder 302 may transcode received content into an MPEG-2 transport stream and deliver the content to a packager 304. The packager 304 may segment the content received from the transcoder 302 and encapsulate the content segments in a container expected by a particular type of adaptive bit rate client. Thus, a whole video may be segmented in to what is commonly referred to as content segments. The packager 304 may create and deliver manifest files. The packager 304 creates the manifest files as the packager 304 performs the segmenting operation for each type of adaptive bit rate streaming method. As an example, the manifest files may be Dynamic Adaptive Streaming over HTTP (“DASH”). In adaptive bit rate protocols, the manifest files generated may include a variant playlist and a playlist file. The variant playlist describes the various formats (resolution, bit rate, codec, etc.) that are available for a given asset or content stream. For each format, a corresponding playlist file may be provided. The playlist file identifies the content fragments that are available to the client. It is noted that the terms manifest files and playlist files may be referred to interchangeably herein. A client determines which format the client desires, as listed in the variant playlist, finds the corresponding manifest/playlist file name and location, and then retrieves content segments referenced in the manifest/playlist file.

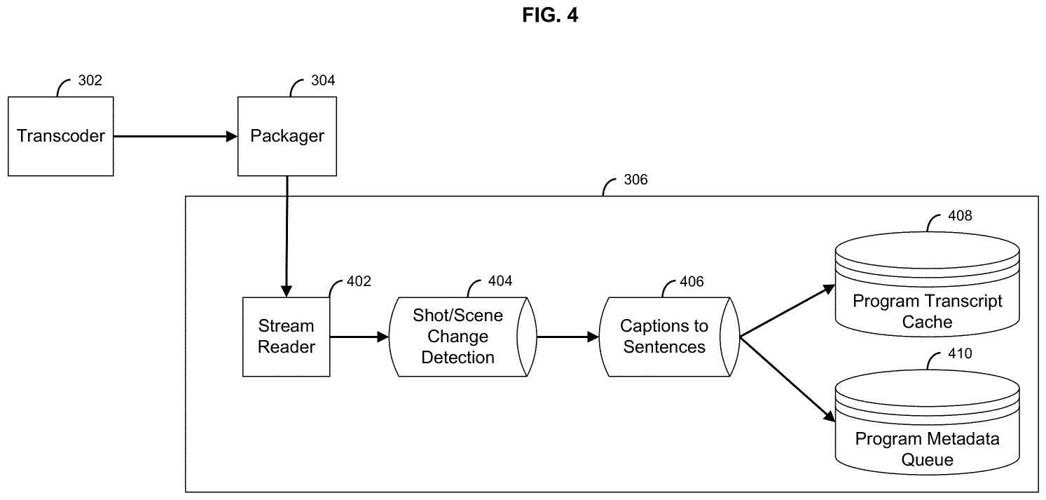

The packager 304 may provide the content segments and the manifest file(s) to a video analysis component 306 (e.g., as an MPEG-4 transport stream via HTTP). The video analysis component 306 may monitor received content segments and/or received manifest to access content segments for analysis. The video analysis component 306 may generate program metadata documents, program transcript documents, and the like. A content segment may be analyzed for shot changes and scene changes. The video analysis component 306 may be configured to determine transitions in content (e.g., shot changes and scene changes). A transition in content may be a scene change, which may be a change in location or time of a show that acts as a cue to the viewer. The video analysis component 306 may extract closed captioning data and perform a speech-to-text function as needed. Functionality of the video analysis component 306 is further described with regard to FIG. 4. The video analysis component 306 may store, or cause storage of, program metadata documents, program transcript documents, and the like.

A search component 308 may receive a query from a user device, such as the user device 220, the media device 120, controllable device 230, user device 110, mobile device 124, etc. The query may be indicative of a user command to control presentation of content at a content presentation device 310 (e.g., controllable device 230, user device 110, media device 120, mobile device 124, etc.). The command may be time-driven, context-driven, or a combination of both. For example, the command may indicate presentation of the content is to end a certain time; after a specified event occurs within the content; or at a certain time and/or at a specified event (e.g., whichever occurs first). The search component 308 may attempt to match the query to the closed captioning data and/or speech-to-text data to identify one or more matches. The search component 308 may generate match metadata (e.g., a content identifier, a location of the match, a start boundary, an end boundary, or a combination thereof), content transition timelines, and the like. The search component 308 may store, or cause storage of, the match metadata, the content transition timelines, and the like. An occurrence of a match enables identification of an end boundary. The search component 308, upon identifying an end boundary, may provide data such as a content identifier, a start boundary corresponding to a timestamp of the content at which the query was received, the end boundary, or a combination thereof, to the content presentation device 310. The content presentation device 310 may be, for example, a television, set-top box, mobile device, a laptop, a computer, a combination thereof, and/or the like. The content presentation device 310 may be a component of the user device 220.

The content presentation device 310 may cause presentation of content to be terminated at the end boundary (e.g., a timestamp of the content). For example, a query of “Turn off the television in 20 minutes” may cause the search component 308 to provide data to the content presentation device 310 that causes the content presentation device 310 to power off/terminate presentation of content at an end boundary corresponding to a timestamp in the content that occurs 20 minutes after the query was received. As another example, a query of “Turn off the television after the princess has been saved” may cause the search component 308 to provide data to the content presentation device 310 that causes the content presentation device 310 to power off/terminate presentation of content at an end boundary corresponding to a point in the content where it is determined (e.g., by the search component 308 as described herein) that the princess has been saved.

FIG. 4 shows an example of a video analysis performed by the video analysis component 306. The transcoder 302 may provide content that is encoded to a packager 304. For example, the content may be encoded using MPEG 2, and the transcoder 302 can provide the content via Multicast. A stream reader 402 may monitor content manifests from the packager 304. For example, the packager 304 may provide manifests to the stream reader 402 via HTTP DASH. The stream reader 402 may scale horizontally enabling consumption of a plurality of streams, for example, over 10,000 local and/or national streams. Each time a monitored manifest is updated, video segments from the monitored manifest are retrieved and video frames may be analyzed for shot and scene changes by shot/scene change detection component 404.

The shot/scene change detection component 404 may utilize SCTE-35 signaling in the manifest to determine local ad spots and identifying a scene change. When SCTE-35 signaling is not available, shot and scene detection algorithms may identify content transitions by decoding image packets for color and edge information and applying mathematical formulas to detect movement from one frame to the next. A shot change may be determined by comparing color histograms of adjacent video frames and applying a threshold to that difference. Shot changes may be determined to exist wherever the difference in the color histograms of adjacent frames exceeds this threshold.

In an example, once the shot/scene change detection component 404 detects one or more shot changes and/or scene changes, a captions-to-sentences component 406 may process closed captioning data. Each video segment may carry an encoder boundary point (EBP) containing a sequential timestamp relative to the transcoder 302. The captions-to-sentences component 406 may extract timestamps from the content. For example, the captions-to-sentences component 406 may extract EBP timestamps along with textual Closed Captioning (CEA-608/708) data, which resides in picture user data on the content stream. As another example, the component 404 can detect signals encoded within the content stream. For example, the content may be encoded with signals (e.g., using the SCTE-35 standard) that indicate changes in the content, such as scene changes. These scene changes may be used to determine the end boundary, such as an end boundary associated with a query/command received by a user device (e.g., “Turn off the television at the end of the next scene.”). As a further example, the captions to sentences component 406 can determine speech from audio associated with the content. The captions to sentences component 406 can then convert the audio to text (e.g., speech to text conversion). Sentence formation is constructed if there is a partial phrase. A series of phrases, which ultimately form a sentence, may be spread over multiple video segments. Multiple video segments may result in more than one shot or scene change. All shot and scene change times may be reflected as an array of timestamps (e.g., EBP times) in a program metadata document.

Once a sentence is formed it may be included in the resulting program metadata document, which may then be pushed onto a program metadata queue 410 making it available for search. A program transcript document may also be maintained for each program (e.g., show, movie, etc.). The insertion of the timestamps (e.g., the EBP time) in front of each sentence allows downstream search components to have transcoder time relevant sentences for use cases requiring a full transcript search. All content transitions may also be recorded in the program transcript document. Resulting program transcript documents may be maintained in a program transcript cache 408.

The search component 308 may be used to search the stream. In an example, the search component 308 may be used to search the stream after the video analysis component 306 has analyzed at least a portion of a stream. Typical search engines may store static documents, build one or more inverted indexes, and execute queries against the indexes. The search component 308 may invert this concept by creating one or more indexes of a query or queries. As program metadata documents arrive and/or are generated, the program metadata documents are tokenized and searched against the query indexes. For example, a query/command received by a user device to “Turn off the television after the princess has been saved” may cause the search component 308 to search one or more query indexes associated with the word “princess” (or a synonym thereof). The search component 308 may search the one or more query indexes to determine an end boundary (e.g., a timestamp) that corresponds to Closed Captioning data (e.g., previously extracted by the captions-to-sentences component 406) containing the words “princess” and “saved” (or synonyms thereof). The search component 308 may provide data to the content presentation device 310 that is indicative of the end boundary and causes the content presentation device 310 to power off/terminate presentation of the content at the end boundary.

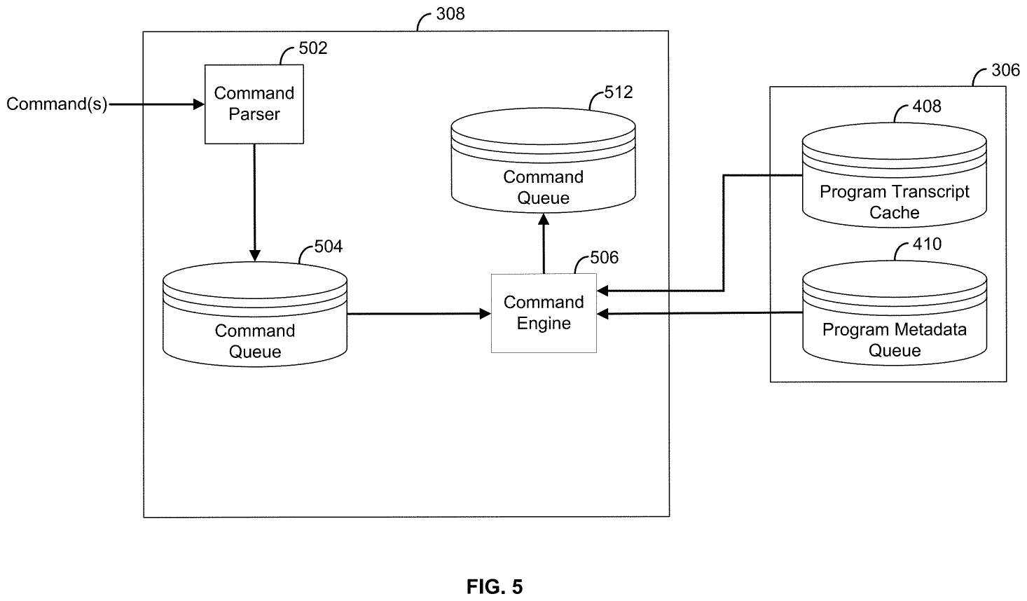

FIG. 5 shows example components of the search component 308. A command parser 502 may receive one or more queries and may filter and/or expand the one or more queries. Editorialized synonyms may be used to expand popular searches into broader meanings. For example, the two queries “bad guy” and “enemy” would result in the same query “bad buy OR enemy”. Queries may then be normalized into an internal query representation and submitted to a command queue 504. A command engine 506 may apply commands from the command queue 504 to one or more of the program transcript cache 408 and/or the program metadata queue 410 of the video analysis component 306. The command engine 506 may identify content transitions before and/or after the time of a query match. The moment of a commercial end may be used as the end boundary. A scene change that occurs at some time after the match may represent the end boundary of the video clip. The command engine 506 utilizes a cached content transition timeline from the program metadata queue to an end boundary based on the query.

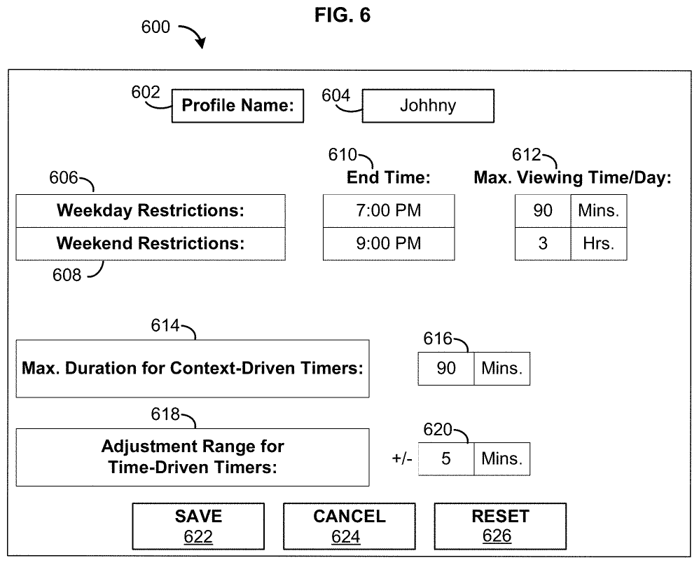

FIG. 6 shows an example user profile interface 600 for a profile 602 of a user 604 of a user device that presents content. One or more settings of the profile 602 may dictate how a command associated with presentation of content is processed. Daily profile settings 606, 608 may relate to the user's ability to watch content on a given day (e.g., weekday vs. weekend). For example, the daily profile settings 606, 608 may include corresponding times 610 at which content presented to the user 604 is caused to be terminated. The daily profile settings 606, 608 may also include a corresponding maximum amount of time 612 the user 604 may watch content on a given day. After the user 604 has watched content for the maximum amount of time 612, the user device may be caused to terminate content being presented to the user. That is, regardless of any remaining time/content associated with a context-driven or time-driven command, the user device may be caused to terminate content being presented to the user 604 based on the maximum amount of time 612 indicated by the profile 602 for the user 604. As shown in FIG. 6, the maximum amount of time 612 may be different for weekdays as compared to weekends; however, it should be noted the maximum amount of time 612 may be the same for weekdays as well as weekends. Further, the maximum amount of time 612 may be adjusted by an authorized user, such as a parent or guardian of the user 604. The authorized user may reward the user 604 by entering a command at the user device that adjusts the maximum amount of time 612 for the user 604. For example, the authorized user may enter a command at the user device indicating the user 604 (e.g., a child of the family) is to be permitted to watch an additional hour of content on a given night. As a result, the maximum amount of time 612 may be adjusted and any time-driven, context-driven, or combination command received on the given night may be affected by the reward (e.g., a command to turn of the television in 20 minutes may be adjusted to 1 hour and 20 minutes to reflect the reward).

The profile 602 may include a context-driven content control setting 614 that dictates how a context-driven command is processed. The context-driven content control setting 614 may include an amount of time 616 that represents a maximum amount of time content may continue to be presented to the user 604 after a context-driven command is received. For example, a context-driven command may be to “Turn the television off once the princess has been saved.” The systems and methods described herein may determine a timestamp that corresponds to an end boundary indicated by the context-driven command (e.g., a timestamp corresponding to the princes being saved). The determined end boundary may not be reached by the user device until two hours after the command was received. Two hours may be greater than the amount of time 616, in which case the context-driven content control setting 614 may cause the user device to terminate presentation of content 90 minutes after the command was received, despite the determined end boundary having not been reached by the user device.

The profile 602 may also include an adjustment range setting 618 for time-driven commands that dictates how a time-driven command is processed. The adjustment range setting 618 may include a range of time 620 associated with an end boundary that is determined in response to receiving a time-driven command. For example, a time-driven command may be to “Turn the television off in 20 minutes.” The systems and methods described herein may determine a timestamp that corresponds to an end boundary indicated by the time-driven command (e.g., a timestamp corresponding to 20 minutes after the command was received). The systems and methods described herein may further determine that a content transition occurs within the range of time 620 around the determined end boundary (e.g., a content transition may be determined to occur in a 5 minute window preceding the end boundary or within a 5 minute window following the end boundary). The determined end boundary may then be adjusted to correspond to a timestamp at a start of the content transition, in which case the adjustment range setting 618 may cause the user device to terminate presentation at the start of the content transition rather than the timestamp that corresponds to the original end boundary as indicated by the time-driven command. The profile 602 may also include a save option 622 (e.g., to save any changes made to the profile 602); a cancel option 624 (e.g., to cancel any changes made to the profile 602); and a reset option 626 (e.g., to reset all settings in the profile 602 to either null values or to predetermined default values).

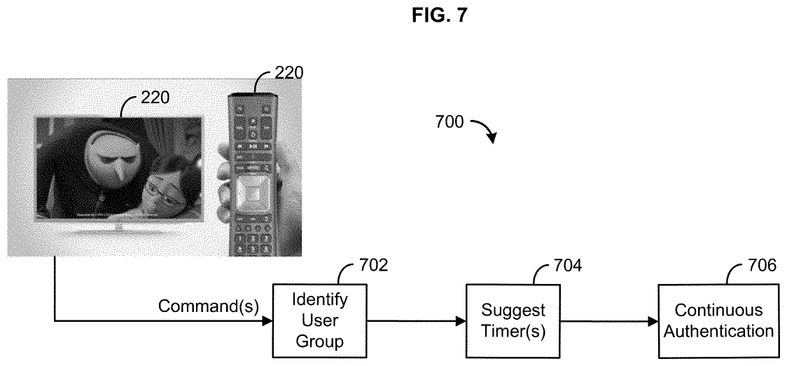

FIG. 7 shows an example operation of a machine learning component 700 of a content presentation/control device, such as the controllable device 230, user device 110, media device 120, mobile device 124, content presentation device 310, etc. At block 702, the machine learning component 700 may identify various users of a user group, such as children of a family, based on content presented, time when the device 220 is used (e.g. children at home may have different schedules), voice signature(s) determined based on commands received at the user device 220, a setup process of the user device 220, and/or various machine learning methods known in the art. For example, an authorized user of the user group, such as a parent, may be identified during a setup process of the user device 220. One or more other users of the user group, such as children of the family, may also be identified during the setup process of the user device 220. The user device 220 may associate the users with respective user profiles as described in FIG. 6. Each respective user profile may include a plurality of profile settings, such as daily restrictions on time content may be presented, a cumulative amount of time content may be presented on a given day and/or during a given session, and the like.

At block 704, the machine learning component 700 may suggest one or more content items and/or associated content controls (e.g., timers) for a given user based on the user's associated user profile settings, historical content watching patterns, expert recommendations, recommended content items from similar users (e.g. based on age, gender, interests etc.), a combination thereof and/or the like. For example, if a user is only permitted, based on their associated user profile, to watch content until 8:00 PM on a given night, and if the current time is 7:25 PM, then the machine learning component 700 may recommend a content item for the user that is 30 minutes long.

An authorized user, such as a parent, may reward a user by entering a command at the user device 220 that adjusts one or more profile settings associated with the user. For example, the authorized user may enter a command indicating that the user (e.g., a child of the family) is to be permitted to watch an additional hour of content on a given night. As a result, any time-driven, context-driven, or combination command received on the given night may be affected by the reward (e.g., a command to turn off the television in 20 minutes may be adjusted to 1 hour and 20 minutes to reflect the reward). At block 706, the machine learning component 700 provides continuous authentication throughout presentation of content for any user. For example, an authorized user may enter a time-driven command at the user device 220 that is intended to cause the user device 220 to terminate presentation of content for a specified user at a given time and/or after a given duration. The machine learning component 700 may prevent the specified user from overriding the command with a further command the specified user enters at the user device 220. For example, the machine learning component 700 may determine that the further command is associated with a voice signature of the specified user rather than the voice signature of the authorized user. Consequently, the machine learning component 700 may cause the user device 220 to disregard the further command.

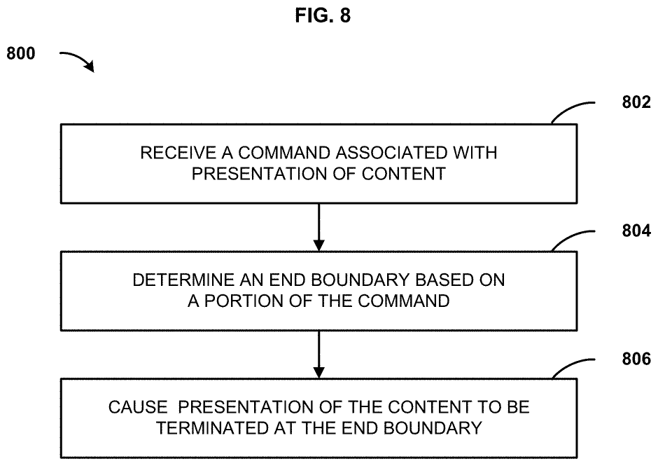

FIG. 8 is a flowchart of an example method 800 for providing intelligent content controls and enforcing the same during presentation of content. Method 800 may be implemented by, for example, the user device 220, the controllable device 230, the user device 110, the media device 120, the mobile device 124, and/or the content presentation device 310. At step 802, a command may be received via a voice-enabled device during presentation of content at a user device. The command may contain one or more search terms and/or phrases. As an example, the command may be received by a voice-enabled device, such as a remote control for a television, a set-top box, a smart speaker, and the like. The voice-enabled device may determine a voice signature associated with the command to ensure the command is being received by an authorized user, such as a parent rather than a child. The command may be received at a first timestamp during presentation of the content.

The command may be context-driven and may include a phrase associated with a scene for the content, such as “Turn the television off once the princess has been saved.” At step 804, an end boundary may be determined. The end boundary may be determined based on a portion of the command relating to metadata associated with presentation of the content at a second timestamp. In the preceding example, the portion of the command may be the words “princess” and “saved.” Content metadata may be searched to identify the second timestamp based on an occurrence of the portion of the command. Upon identifying an occurrence of the portion of the command, the end boundary may be determined. The end boundary may be adjusted to coincide with a content transition nearest the second timestamp (e.g., a shot change, a scene change, etc.). The content transition may be associated with a third timestamp, and the end boundary may be adjusted to correspond to third timestamp.

At step 806, presentation of the content may be terminated at the end boundary (e.g., at the nearest content transition). In the preceding example, the end boundary may be a content transition that occurs directly after the scene in which the princess is saved. After presentation of content is terminated, the user device may be caused to be unresponsive to further commands received for a given amount of time. For example, a setting in the user profile may cause the user device that was presenting the content to be unresponsive to further commands for 20 minutes (or any other amount of time) after presentation of the content was terminated. While the user device that was presenting the content is unresponsive, it may be caused to be powered off, to present a screen saver, and the like. The user device may be caused to become responsive to further commands (e.g., “woken-up”) upon receiving a command at the voice-enabled device that includes a voice signature associated with an authorized user, such as a parent rather than a child.

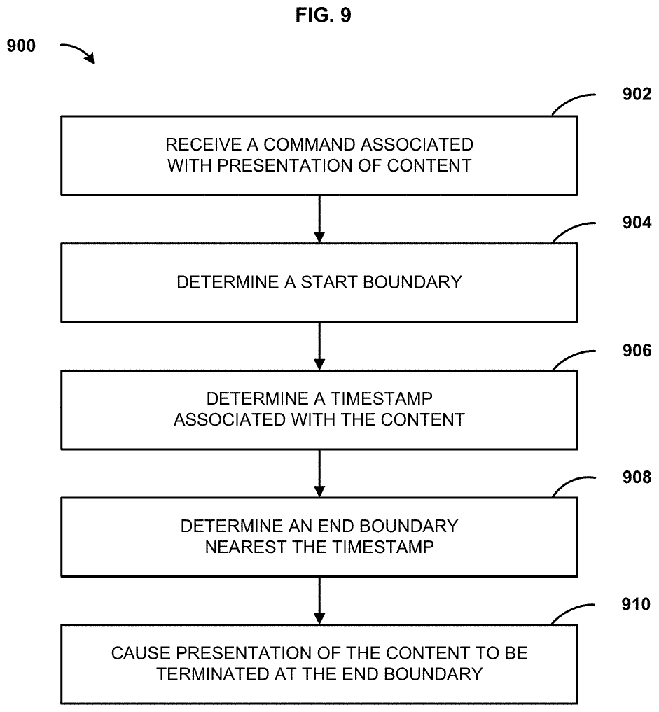

FIG. 9 is a flowchart of an example method 900 for providing intelligent content controls and enforcing the same during presentation of content. Method 900 may be implemented by, for example, the user device 220, the controllable device 230, the user device 110, the media device 120, the mobile device 124, and/or the content presentation device 310. At step 902, a command may be received via a voice-enabled device during presentation of content at a user device. The command may contain one or more search terms and/or phrases. As an example, the command may be received by a voice-enabled device, such as a remote control for a television, a set-top box, a smart speaker, and the like. The voice-enabled device may determine a voice signature associated with a command to ensure the command is being received by an authorized user, such as a parent rather than a child. The command may be received at a first timestamp during presentation of the content. A portion of the command (e.g., one or more of the search terms and/or phrases) may be indicative of a duration of time. For example the command may be a time-driven command that includes the phrase, “Turn the television off in 20 minutes,” in which case the duration of time would be 20 minutes and the first timestamp would be a timestamp that corresponds to the time at which the command was received.

At step 904, a start boundary may be determined based on the first timestamp. For example, the start boundary may indicate a current time, such as 7:00 PM, in which case the duration provided in the command would begin to elapse at 7:00 PM. At step 906, a second timestamp may be determined based on the duration provided in the command and the start boundary. The duration may be an amount of time, and the second timestamp may be determined based on adding the amount of time to the first timestamp. In the preceding example, the second timestamp may be a timestamp of content that corresponds to 20 minutes after the first timestamp, and the user device may reach the second timestamp at 7:20 PM.

At step 908, an end boundary may be determined. The end boundary may be determined based on a third timestamp that is associated with a content transition (e.g., a shot change, a scene change, etc.) occurring during presentation of the content nearest the second timestamp. For example, at step 908, the third timestamp may be determined based on the content transition occurring during presentation of the content nearest the second timestamp, and the end boundary may then be determined based on the third timestamp. A user profile setting may cause the end boundary to be adjusted. For example, the user profile setting may indicate that a given user is only permitted to watch content until 7:15 PM on a given night. The third timestamp may correspond to 7:22 PM, in which case the user profile setting may cause the end boundary to be adjusted to coincide with a fourth timestamp that corresponds to 7:15 PM.

At step 910, presentation of the content may be terminated at the end boundary (e.g., at the nearest content transition). In the preceding example, the end boundary may be a content transition that occurs directly after the second timestamp. After presentation of content is terminated, the user device may be caused to be unresponsive to further commands received for a given amount of time. For example, a setting in the user profile may cause the user device that was presenting the content to be unresponsive to further commands for 20 minutes (or any other amount of time) after presentation of the content was terminated. While the user device that was presenting the content is unresponsive, it may be caused to be powered off, to present a screen saver, and the like. The user device may be caused to become responsive to further commands (e.g., “woken-up”) upon receiving a command at the voice-enabled device that includes a voice signature associated with an authorized user, such as a parent rather than a child.

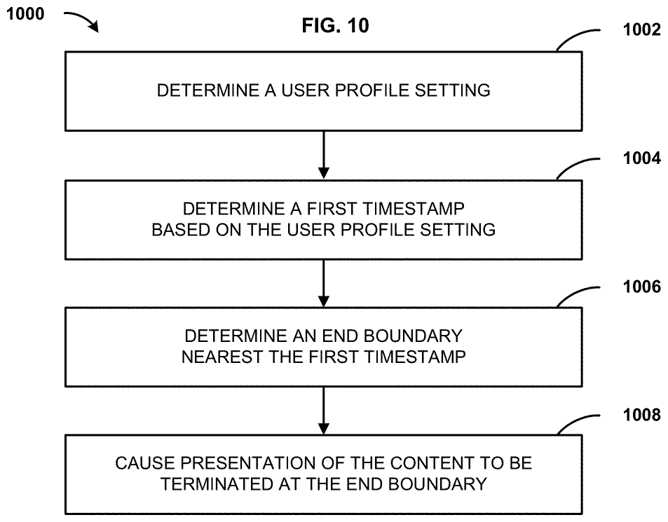

FIG. 10 is a flowchart of an example method 1000 for providing intelligent content controls and enforcing the same during presentation of content. Method 1000 may be implemented by, for example, the user device 220, the controllable device 230, the user device 110, the media device 120, the mobile device 124, and/or the content presentation device 310. At step 1002, a user profile setting associated with enforcement of content controls during presentation of content may be determined (e.g., generated, accessed, sent, received, etc.). For example, the user profile setting may indicate that a given user is only permitted to watch content until 8:00 PM on a given night, in which case the first timestamp may correspond to 8:00 PM. As another example, the user profile setting may indicate that a given user is only permitted to watch 2 hours of content in the aggregate during a given interval, such as a duration of time, a number of days, or a number of content presentation sessions occurring on a single day. At step 1004, a first timestamp associated with presentation of the content may be determined. The first timestamp may be determined based on the setting in the user profile.

At step 1006, an end boundary may be determined. The end boundary may be determined based on a second timestamp that is associated with a content transition (e.g., a shot change, a scene change, etc.) occurring during presentation of the content nearest the first timestamp. For example, at step 1004, the second timestamp may be determined based on the content transition occurring during presentation of the content nearest the first timestamp, and the end boundary may then be determined based on the second timestamp. The second timestamp may be within a range of time on either end of the first timestamp (e.g., +/−5 minutes). The range of time may be indicated in the user profile.

A command may be received via a voice-enabled device during presentation of content at the user device. The command may contain one or more search terms and/or phrases. The command may be received by a voice-enabled device, such as a remote control for a television, a set-top box, a smart speaker and the like. The voice-enabled device may determine a voice signature associated with the command to ensure the command is being received by an authorized user, such as a parent rather than a child.

In one example, the command may be context-driven and may include a phrase, such as “Turn the television off once the princess has been saved.” The end boundary may be determined based on a portion of the command relating to metadata associated with presentation of the content at the second timestamp, which may occur prior to or after the first timestamp. The end boundary may be adjusted to coincide with a content transition nearest the second timestamp (e.g., a shot change, a scene change, etc.). The content transition may be associated with a third timestamp, and the end boundary may be adjusted to correspond to third timestamp.

In another example, the command may be time-driven. A portion of the command (e.g., one or more of the search terms and/or phrases) may be indicative of a duration of time. The command may be received at a third timestamp occurring prior to the first timestamp and the second timestamp. A start boundary may be determined based on the third timestamp. A fourth timestamp may be determined based on the duration provided in the command and the start boundary. The duration may be an amount of time, and the fourth timestamp may be determined based on adding the amount of time to the third timestamp. The end boundary may be determined based on the duration and the second timestamp associated with the content transition occurring during presentation of the content nearest the first timestamp. The second timestamp may occur within the duration.

At step 1008, presentation of the content to be terminated at the end boundary. After presentation of content is terminated, the user device may be caused to be unresponsive to further commands received for a given amount of time. For example, a setting in the user profile may cause the user device that was presenting the content to be unresponsive to further commands for 20 minutes (or any other amount of time) after presentation of the content was terminated. While the user device that was presenting the content is unresponsive, it may be caused to be powered off, to present a screen saver, and the like. The user device may be caused to become responsive to further commands (e.g., “woken-up”) upon receiving a command at the voice-enabled device that includes a voice signature associated with an authorized user, such as a parent rather than a child.

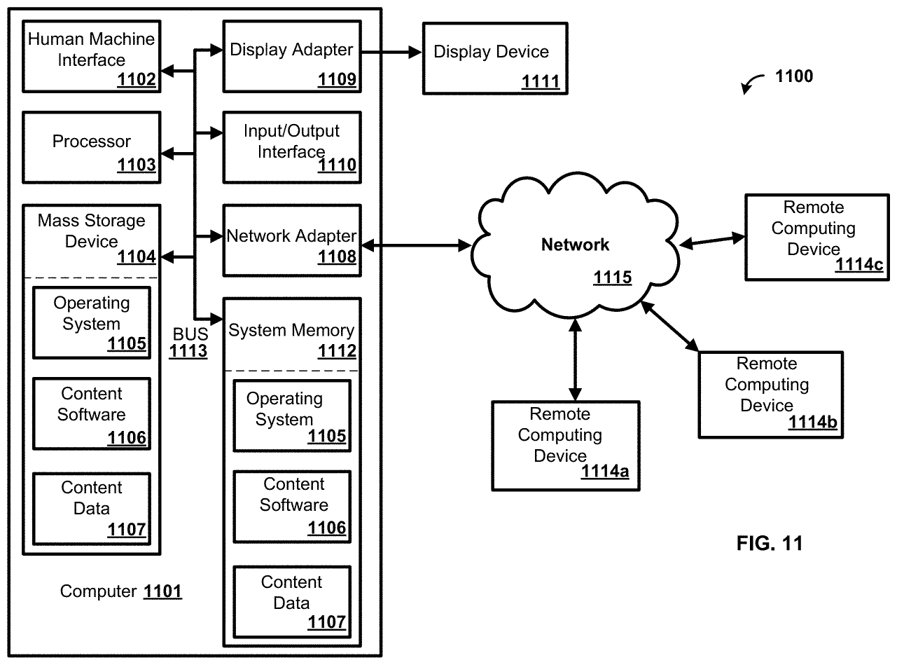

In an example, the methods and systems may be implemented on a computer 1101 as shown in FIG. 11 and described below. By way of example, the edge device 128, the user device 220, the controllable device 230, the user device 110, the media device 120, the mobile device 124, and/or the content presentation device 310 may be a computer as shown in FIG. 11. Similarly, the methods and systems described herein may utilize one or more computers to perform one or more functions in one or more locations. FIG. 11 is a block diagram showing an example of an operating environment for performing the described methods. This operating environment is only an example of an operating environment and is not intended to suggest any limitation as to the scope of use or functionality of operating environment architecture. Neither should the operating environment be interpreted as having any dependency or requirement relating to any one or combination of components shown in the example operating environment.

The present methods and systems may be operational with numerous other general purpose or special purpose computing system environments or configurations. Examples of well-known computing systems, environments, and/or configurations that may be suitable for use with the systems and methods comprise, but are not limited to, personal computers, server computers, laptop devices, and multiprocessor systems. Additional examples comprise set-top boxes, programmable consumer electronics, network PCs, minicomputers, mainframe computers, distributed computing environments that comprise any of the above systems or devices, and the like.

The processing of the described methods and systems may be performed by software components. The systems and methods described herein may be described in the general context of computer-executable instructions, such as program modules, being executed by one or more computers or other devices. Generally, program modules comprise computer code, routines, programs, objects, components, data structures, etc. that perform particular tasks or implement particular abstract data types. The described methods may also be practiced in grid-based and distributed computing environments where tasks are performed by remote processing devices that are linked through a communications network. In a distributed computing environment, program modules may be located in both local and remote computer storage media including memory storage devices.

Further, one skilled in the art will appreciate that the systems and methods described herein may be implemented via a general-purpose computing device in the form of a computer 1101. The components of the computer 1101 may include, but are not limited to, one or more processors 1103, a system memory 1112, and a system bus 1113 that couples various system components including the one or more processors 1103 to the system memory 1112. The system may utilize parallel computing.

The system bus 1113 represents one or more of several possible types of bus structures, including a memory bus or memory controller, a peripheral bus, an accelerated graphics port, or local bus using any of a variety of bus architectures. By way of example, such architectures may include an Industry Standard Architecture (ISA) bus, a Micro Channel Architecture (MCA) bus, an Enhanced ISA (EISA) bus, a Video Electronics Standards Association (VESA) local bus, an Accelerated Graphics Port (AGP) bus, and a Peripheral Component Interconnects (PCI), a PCI-Express bus, a Personal Computer Memory Card Industry Association (PCMCIA), Universal Serial Bus (USB) and the like. The bus 1113, and all buses specified in this description may also be implemented over a wired or wireless network connection and each of the subsystems, including the one or more processors 1103, a mass storage device 1104, an operating system 1105, content software 1106, content data 1107, a network adapter 1108, the system memory 1112, an Input/Output Interface 1110, a display adapter 1109, a display device 1111, and a human machine interface 1102, may be contained within one or more remote computing devices 1114a,b,c at physically separate locations, connected through buses of this form, in effect implementing a fully distributed system.

The computer 1101 typically comprises a variety of computer readable media. Examples of readable media may be any available media that is accessible by the computer 1101 and comprises, for example and not meant to be limiting, both volatile and non-volatile media, removable and non-removable media. The system memory 1112 comprises computer readable media in the form of volatile memory, such as random access memory (RAM), and/or non-volatile memory, such as read only memory (ROM). The system memory 1112 typically contains data such as the content data 1107 and/or program modules such as the operating system 1105 and the content software 1106 that are immediately accessible to and/or are presently operated on by the one or more processors 1103.

In another example, the computer 1101 may also comprise other removable/non-removable, volatile/non-volatile computer storage media. By way of example, FIG. 11 shows an example mass storage device 1104 which may provide non-volatile storage of computer code, computer readable instructions, data structures, program modules, and other data for the computer 1101. For example and not meant to be limiting, the mass storage device 1104 may be a hard disk, a removable magnetic disk, a removable optical disk, magnetic cassettes or other magnetic storage devices, flash memory cards, CD-ROM, digital versatile disks (DVD) or other optical storage, random access memories (RAM), read only memories (ROM), electrically erasable programmable read-only memory (EEPROM), and the like.

Optionally, any number of program modules may be stored on the mass storage device 1104, including by way of example, the operating system 1105 and the content software 1106. Each of the operating system 1105 and the content software 1106 (or some combination thereof) may include elements of the programming and the content software 1106. The content data 1107 may also be stored on the mass storage device 1104. The content data 1107 may be stored in any of one or more databases known in the art. Examples of such databases comprise, DB2®, Microsoft® Access, Microsoft® SQL Server, Oracle®, mySQL, PostgreSQL, and the like. The databases may be centralized or distributed across multiple systems.

In another example, the user may enter commands and information into the computer 1101 via an input device (not shown). Examples of such input devices comprise, but are not limited to, a keyboard, pointing device (e.g., a “mouse”), a microphone, a joystick, a scanner, tactile input devices such as gloves, and other body coverings, and the like These and other input devices may be connected to the one or more processors 1103 via the human machine interface 1102 that is coupled to the system bus 1113, but may be connected by other interface and bus structures, such as a parallel port, game port, an IEEE 1394 Port (also known as a Firewire port), a serial port, or a universal serial bus (USB).

In yet another example, the display device 1111 may also be connected to the system bus 1113 via an interface, such as the display adapter 1109. It is contemplated that the computer 1101 may have more than one display adapter 1109 and the computer 1101 may have more than one display device 1111. For example, the display device 1111 may be a monitor, an LCD (Liquid Crystal Display), or a projector. In addition to the display device 1111, other output peripheral devices may include components such as speakers (not shown) and a printer (not shown) which may be connected to the computer 1101 via the Input/Output Interface 1110. Any step and/or result of the methods may be output in any form to an output device. Such output may be any form of visual representation, including, but not limited to, textual, graphical, animation, audio, tactile, and the like. The display device 1111 and computer 1101 may be part of one device, or separate devices.

The computer 1101 may operate in a networked environment using logical connections to one or more remote computing devices 1114a,b,c. By way of example, a remote computing device may be a personal computer, portable computer, smartphone, a server, a router, a network computer, a peer device or other common network node, and so on. Logical connections between the computer 1101 and a remote computing device 1114a,b,c may be made via a network 1115, such as a local area network (LAN) and/or a general wide area network (WAN). Such network connections may be through the network adapter 1108. The network adapter 1108 may be implemented in both wired and wireless environments. Such networking environments are conventional and commonplace in dwellings, offices, enterprise-wide computer networks, intranets, and the Internet.

The application programs and other executable program components such as the operating system 1105 are shown herein as discrete blocks, although it is recognized that such programs and components reside at various times in different storage components of the computing device 1101, and are executed by the one or more processors 1103 of the computer. An implementation of the content software 1106 may be stored on or transmitted across some form of computer readable media. Any of the described methods may be performed by computer readable instructions stored on computer readable media. Computer readable media may be any available media that may be accessed by a computer. By way of example and not meant to be limiting, computer readable media may include “computer storage media” and “communications media.” “Computer storage media” comprise volatile and non-volatile, removable and non-removable media implemented in any methods or technology for storage of information such as computer readable instructions, data structures, program modules, or other data. Examples of a computer storage media comprise, but are not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which may be used to store the desired information and which may be accessed by a computer.

The methods and systems may employ Artificial Intelligence techniques such as machine learning and iterative learning. Examples of such techniques include, but are not limited to, expert systems, case based reasoning, Bayesian networks, behavior based AI, neural networks, fuzzy systems, evolutionary computation (e.g. genetic algorithms), swarm intelligence (e.g. ant algorithms), and hybrid intelligent systems (e.g. Expert inference rules generated through a neural network or production rules from statistical learning).

While the methods and systems have been described in connection with specific examples, it is not intended that the scope be limited to the particular examples set forth, as the examples herein are intended in all respects to be illustrative rather than restrictive.

Unless otherwise expressly stated, it is in no way intended that any method set forth herein be construed as requiring that its steps be performed in a specific order. Accordingly, where a method claim does not actually recite an order to be followed by its steps or it is not otherwise specifically stated in the claims or descriptions that the steps are to be limited to a specific order, it is in no way intended that an order be inferred, in any respect. This holds for any possible non-express basis for interpretation, including: matters of logic with respect to arrangement of steps or operational flow; plain meaning derived from grammatical organization or punctuation; the number or type of examples described in the specification.

It will be apparent to those skilled in the art that various modifications and variations may be made without departing from the scope or spirit. Other embodiments will be apparent to those skilled in the art from consideration of the specification and practice described herein. It is intended that the specification and examples be considered as exemplary only, with a true scope and spirit being indicated by the following claims.

What is claimed is:

1. A method comprising:
receiving a command associated with enforcement of content controls during presentation of a scene of content;
determining, based on a portion of the command relating to metadata associated with the scene of the content and a timestamp, an end boundary; and
causing presentation of the content to be terminated at the end boundary.

2. The method of claim 1, wherein the command comprises a voice signature.

3. The method of claim 2, further comprising determining, based on the voice signature, that the command is authorized.

4. The method of claim 1, wherein the portion of the command comprises one or more keywords relating to the metadata associated with the scene of the content and the timestamp.

5. The method of claim 1, wherein the content is presented at a user device, and wherein causing presentation of the content to be terminated at the end boundary comprises one or more of:
causing the user device to power off at the timestamp;
causing the user device to disregard a further command received at the user device at or following the timestamp; or
causing the user device to present a screensaver at the timestamp.

6. The method of claim 1, further comprising determining, based on a content transition occurring during presentation of the content nearest the timestamp, an adjusted end boundary, wherein presentation of the content is caused, based on the adjusted end boundary, to be terminated at the content transition.

7. The method of claim 1, further comprising:
determining, based on a user profile setting, a second timestamp associated with the content; and
determining, based on a content transition occurring during presentation of the content nearest the second timestamp, an adjusted end boundary, wherein presentation of the content is caused, based on the adjusted end boundary, to be terminated at the content transition.

8. A method comprising:
receiving a command associated with enforcement of content controls during presentation of content, wherein the command comprises a duration and is associated with a first timestamp;
determining, based on the first timestamp, a start boundary;
determining, based on the duration and the start boundary, a second timestamp associated with the content;
determining, based on a content transition occurring during presentation of the content nearest the second timestamp, a third timestamp;
determining, based on the third timestamp, an end boundary; and
causing presentation of the content to be terminated at the end boundary.

9. The method of claim 8, wherein the command comprises a voice signature.

10. The method of claim 9, further comprising determining, based on the voice signature, that the command is authorized.

11. The method of claim 8, wherein the content is presented at a user device, and wherein causing presentation of the content to be terminated at the end boundary comprises one or more of:
causing the user device to power off at the third timestamp;
causing the user device to disregard a further command received at the user device at or following the third timestamp; or
causing the user device to present a screensaver at the third timestamp.

12. The method of claim 8, wherein the duration is an amount of time, and wherein the second timestamp is determined based on adding the amount of time to the first timestamp.

13. The method of claim 8, wherein the command comprises one or more keywords, and wherein determining the end boundary is further based on the one or more keywords relating to metadata associated with the content at the third timestamp.

14. The method of claim 8, further comprising:
determining, based on a user profile setting, an adjusted end boundary, wherein the adjusted end boundary occurs at a fourth timestamp that is prior to one or more of the second timestamp or the third timestamp; and
causing presentation of the content to be terminated at the adjusted end boundary.

15. A method comprising:
determining a user profile setting associated with enforcement of content controls during presentation of content;
determining, based on the user profile setting, a first timestamp associated with presentation of the content;
determining, based on a content transition occurring during presentation of the content nearest the first timestamp, a second timestamp;
determining, based on the second timestamp, an end boundary; and
causing presentation of the content to be terminated at the end boundary.

16. The method of claim 15, wherein the user profile setting comprises one or more of a time of day or an aggregate amount of time of content presentation within an interval.

17. The method of claim 16, wherein the interval comprises a duration of time, a number of days, or a number of content presentation sessions occurring on a single day.

18. The method of claim 15, wherein determining, based on the second timestamp, an end boundary comprises:
receiving a command associated with the content; and
determining, based on a portion of the command relating to metadata associated with the content at the second timestamp, the end boundary.

19. The method of claim 15, wherein determining, based on the second timestamp, an end boundary comprises:
receiving a command associated with enforcement of content controls during presentation of the content, wherein the command comprises a duration and is associated with a third timestamp occurring prior to the first timestamp and the second timestamp;
determining, based on the third timestamp, a start boundary;
determining, based on the duration and the third timestamp, a fourth timestamp associated with the content; and
determining, based on the duration and the second timestamp associated with the content transition occurring during presentation of the content nearest the first timestamp, the end boundary, wherein the second timestamp occurs within the duration.

20. The method of claim 15, wherein the content is presented at a user device, and wherein causing presentation of the content to be terminated at the end boundary comprises one or more of:
causing the user device to power off at the second timestamp;
causing the user device to disregard a further command received at the user device at or following the second timestamp; or
causing the user device to present a screensaver at the second timestamp.
